(19) United States
(12) Patent Application Publication
(10) Pub. No.: US 2001/0047322 A1
(43) Pub. Date: Nov. 29, 2001

(54) Method and system for matching bids

(76) Inventors: Tony A. Plate, Sante Fe, NM (US); Robert R. MacDonald, Santa Fe, NM (US)

Correspondence Address: PENNIE & EDMONDS LLP, 1667 K STREET NW, SUITE 1000, WASHINGTON, DC, 20006

(21) Appl. No.: 09/768,817

(22) Filed: Jan. 25, 2001

Related U.S. Application Data
(60) Provisional application No. 60/177,926, filed on Jan. 25, 2000.
(60) Provisional application No. 60/177,927, filed on Jan. 25, 2000.

(51) Int. Cl. G06F 17/60

(52) U.S. Cl. 705/37; 705/26

(57) ABSTRACT

The present invention relates generally to a method and system for matching requests with capabilities for goods and/or services under a set of constraints which arise from conditions among the requests and capabilities. More specifically, the method and system of the present invention receives alternative requests and bids, receives conditions among these alternatives and determines combinations of these alternatives that satisfy these conditions.

### RELATED APPLICATIONS

The present invention claims priority to U.S. provisional application No. 60/177,926 filed on Jan. 25, 2000, titled, “A Supply Chain Automated Matching Marketplace”, the contents of which are herein incorporated by reference. The present invention also claims priority to U.S. provisional application No. 60/177,927, titled, “Collaborative Exchanges for Supply Chain Operation”, the contents of which are herein incorporated by reference.

### FIELD OF THE INVENTION

The present invention relates generally to a method and system for matching requests with capabilities for goods and/or services under a set of constraints which arise from conditions among the requests and capabilities. More specifically, the method and system of the present invention receives alternative requests and bids, receives conditions among these alternatives and determines combinations of these alternatives that satisfy these conditions.

### BACKGROUND

Existing business-to-business e-commerce markets allow businesses to purchase and sell products and services via various auction techniques. These automated markets provide a method for buyers to post their needs and for sellers to competitively bid to meet those needs.

But there are at least two major drawbacks to these markets. First, a critical mass of buyers and sellers must be attracted to the market in order to provide the liquidity to provide competitive bids. Second, the bidding process is inconsistent with the closer relationship needed between members of a supply chain in order to reduce inventories and costs across the supply chain, not just by its individual members.

Accordingly, there exists a need for a system and method for matching bids from buyers and sellers that works well independent of the number of participants and achieves a benefit across a supply chain.

### SUMMARY OF THE INVENTION

It is an aspect of the present invention to present a method for determining one or more matches among one or more bids submitted by one or more participants comprising the steps of:

defining one or more alternatives for at least one of the bids;

defining one or more conditions among said one or more alternatives; and

determining one or more combinations of said alternatives that satisfy said one or more conditions.

It is a further aspect of the present invention to present a method for determining one or more matches among one or more bids submitted by one or more participants wherein said determining one or more combinations of said alternatives that satisfy said one or more conditions step comprises the steps of:

representing said one or more alternatives and/or said one or more conditions with at least one satisfiability problem and

determining at least one solution to said at least one satisfiability problem.

It is a further aspect of the present invention to present computer executable software code stored on a computer readable medium, the code for determining one or more matches among one or more bids submitted by one or more participants, the code comprising:

code to receive one or more alternatives for at least one of the bids;

code to receive one or more conditions among said one or more alternatives; and

code to determine one or more combinations of said alternatives that satisfy said one or more conditions.

It is a further aspect of the present invention to present a programmed computer system for determining one or more matches among one or more bids submitted by one or more participants comprising at least one memory having at least one region storing computer executable program code and at least one processor for executing the program code stored in said memory, wherein the program code includes

code to receive one or more alternatives for at least one of the bids;

code to receive one or more conditions among said one or more alternatives; and

code to determine one or more combinations of said alternatives that satisfy said one or more conditions.

### BRIEF DESCRIPTION OF THE DRAWINGS

FIG. 1 shows the implementation and the use of layers by the present invention.

FIG. 2 shows the architecture and interactions of the collaborative exchange.

FIG. 3 shows a simple request and response.

FIG. 4 shows a request and response having more flexibility than the simple request and response.

FIGS. 5 and 6 show four linked flexible requests and responses.

FIG. 7 discloses a representative computer system in conjunction with which the embodiments of the present invention may be implemented.

### DETAILED DESCRIPTION OF THE PREFERRED EMBODIMENT

### 1 Overview

The Collaborative Exchange of the present invention is an electronic marketplace designed to enable the operation of next-generation supply chains. It is designed to perform information exchange and transactions in a way that facilitates collaboration, synchronization and immediate response in the entire supply chain. The Collaborative Exchange will initially consist of three layers: (1) an Information Exchange layer to provide global visibility of consumer demand and supply chain activity throughout the supply chain, (2) an Execution layer to support transactions among supply chain partners; (3) a Collaborative Optimization layer to support collaboration and synchronization in the entire supply chain and (4) a layer supporting futures and options. The features provided by this fourth layer will participants to reduce excess exposure to risk and increase participant's ability to take advantage of new opportunities. The design of the Collaborative Exchange is such that the four layers can be utilized in a phased manner.

The global visibility provided by the Information Exchange layer implies a vast increase in the amount and variety of information companies have available to them. The successful firms in the future marketplace will be the ones that can best handle this information, make decisions based upon it, and then execute those decisions, all in a timely manner. The first three layers of the Collaborative Exchange support these activities. Firms may enter information on supply and demand, their resources and preferences, capabilities and constraints, locations and flexibility, prices and costs. Demand requests, fulfillment responses, volumes, locations, lead-times, delivery times, preferences, etc. are all linked.

The exchange finds the best way of matching “capabilities” to “requests”, and thereby assigns resources to jobs, at prices determined either by existing contracts or by the balance of supply and demand available in the market and the combination of the requirements necessary to fulfill the request. For example, a transport service provider does not bid solely on a single lane/route. They bid for combinations of routes, so that when the market clears they are assigned a sequence of jobs, pick-ups and deliveries that maximize their supply chain preferences versus costs in the competitive environment of all other carriers bidding on similar routes.

Although Collaborative Optimization has some similarities to real-time matching in an online auction or exchange, it allows many more dimensions of value than just the price of the goods or service. Fulfillment capabilities and demand requests can be described on a rich set of dimensions to fully express their true value. Interdependencies among demand requests and fulfillment responses can also be expressed. Price may not even enter into consideration—matches may be made under existing contracts or agreements between supply chain partners. Collaborative Optimization can both respect and support the alliances and partnerships that are so essential to the smooth operation of the modern supply chain.

The entire Collaborative Exchange involve significant private and shared infrastructure. Pre-existing or best-in-class components are used wherever possible, (e.g., an e-commerce platform for the execution layer.) Firms may interface their existing ERP, optimization and scheduling and/or purchasing systems to the Collaborative Exchange, or may desire to update or invest in additional systems to take advantage of the new opportunities to further improve their operations in a flow environment.

### 1.1 Overall Benefits

The supply-chain wide benefits of the Collaborative Exchange include the following:

1. Lower out-of-stocks at the shelf, resulting in higher revenues

2. Lower inventory; benefits will accrue to each partner along the supply chain corresponding to improvement in cash from lower inventory carrying costs

3. Improved resource utilization, resulting in lower investment and service costs

The reasons for these benefits include the following:

The existence of an exchange results in global information visibility and allows real-time demand signals to be shared amongst all participants in the supply-chain. This facilitates faster response, resulting in lower inventories and less out-of-stocks at the shelf. The tools associated with and made possible by the market allow participants to better understand costs and values associated with transactions and to price the transactions accordingly.

Global information visibility, more accurate pricing, and faster execution will contribute independently, and concurrently, to greater predictability and superior resource allocation, resulting in better service at lower operating cost. The collaborative negotiation of flexible needs and fulfillment enable streamlined product flow within a consumer-products supply-chain. This results in reduced system inventory and less out-of-stocks at the shelf through increased reliability and faster response. The enabling factor is the ability to negotiate relaxation of system constraints, or other policies, such as batch size and order frequency etc., when justified by the gains to be achieved. Collaborative Optimization also allows participants to better optimize daily operations, resulting in lower operating costs.

### 1.2 Implementation

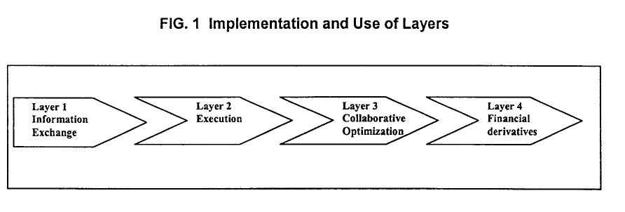

FIG. 1 shows the implementation and the use of layers by the present invention. The Collaborative Exchange can be utilized in a phased manner; layer-by-layer, as shown in FIG. 1. Each layer is designed so that its operation depends only on lower layers: the Information Exchange layer can operate by itself; the execution layer only requires the Information Exchange layer to operate; etc. Each higher layer delivers its own set of benefits and allows further optimization of benefits derived from previous layers. Furthermore, participants at different levels of implementation can still interact with each other through their highest common layer. Implementing each layer of the exchange involves the following tasks:

1. Identification of the best way to provide the shared infrastructure required for the layer: either by using existing or best-in-class products, or creating a new system.

2. Specification of communication protocols. In order to promote interoperability and reduce cost of entry the protocols are XML based and conform to open standards such as those being developed by RosettaNet or UCCNet.

3. Implementation of the shared infrastructure and communication links and protocols.

4. Identification of systems and technical capabilities participants require in order to connect to and gain benefits from use of the shared infrastructure.

5. Evaluation of how participants can best achieve the necessary capabilities: either through using existing systems, updating existing systems, purchasing commercially available systems, or developing new custom systems.

6. Improvement, where necessary, of participants processes, e.g., reduction or elimination of constraints that hamper flow or timely response within the supply chain.

The implementation and use of layers by the present invention eases the transition from current manual or automated systems. The use of layers also allows preparation time for interfacing participants' existing information, transaction and optimization systems to the higher layers of the exchange, or for installing new systems and developing the technical capabilities required to take advantage of the opportunities provided by those higher layers.

### 1.3 Architecture

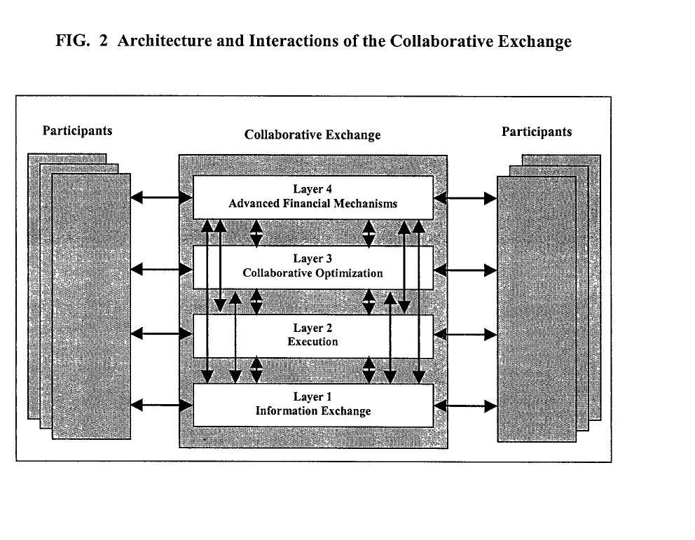

FIG. 2 shows the architecture and interactions of the collaborative exchange. In particular, it shows a high-level schematic of the components and interactions of the Collaborative Exchange, throughout the full scope of participants within the Exchange. Each layer depends on all lower layers, but each layer can operate without higher layers.

Table 1 describes the information processing functions performed by each layer, and where each layer receives information from and sends information to. Table 2 describes the business functions performed by each layer.

TABLE 1
Layers, Functions, and Interactions of the Collaborative Exchange

| | Technical | Gets | Sends |
|---|---|---|---|
| Layer | Functions | Information From | Information To |
| Layer 1: | Information | Smart tag signals | Participants' order |
| Information | filter & router | (consumer | management/ERP |
| Exchange | Database | purchases) | systems, demand |
| | | Requests and | forecasting systems, |
| | | responses sub- | and scheduling |
| | | mitted to layers 2 | systems |
| | | and 3 | |
| | | Transactions | |
| | | performed in | |
| | | layer 2 | |
| Layer 2: | Transaction | | Information |
| Execution | engine | | Exchange Layer |

| | |
|---|---|
| Simple match- | To/from: |
| ing engine | Participants' accounting systems (for |
| Database of | recording transactions) |
| simple requests | Participants' ordering and ERP systems |
| and responses | Participants' pricing systems |
| | (for quoting) |

| | | |
|---|---|---|
| Layer 3: | Advanced | Execution Layer |
| Collaborative | multi- | Information |
| Optimization | dimensional | Exchange Layer |

| | |
|---|---|
| matching/ | To/from: |
| optimization | Participants' ordering and ERP systems |
| engine | Participants' pricing and optimization |
| Database of | systems (for quoting) |
| flexible | |
| requests and | |
| responses | |

| | | |
|---|---|---|
| Layer 4: | Posting | Collaborative |
| (future) | systems for | Optimization layer |
| Advanced | buy/sell orders | Execution layer (for |
| Financial | for derivative | transactions) |
| Mechanisms | offerings | Information |
| | | Exchange layer |

To/from:
Participant's investment- and risk-
management systems, as informed by:
long-term forecasting
strategic decisions
innovation planning

TABLE 2
Business Functions of Layers in the Collaborative Exchange

| | Business Functions |
|---|---|
| Layer 1: | Make visible consumer demand to all participants in the |
| Information | market. |
| Exchange | The information may be filtered and aggregated as |
| | appropriate to maintain levels of confidentiality. |
| | Information about components and raw materials is |
| | propagated to upstream supply-chain members after |
| | exploding transactions according to bills of materials. |
| Layer 2: | Accept requests and responses and make them visible to |
| Execution | appropriate supply-chain participants through the |
| | Information Exchange layer. |
| | Provide simple query and match services. |
| | Execute transactions (i.e., matching requests and |
| | responses) as instructed by participants |
| | Matching and execution may be automated, partly |
| | automated, or manual depending on participant |
| | preference. |
| Layer 3: | Accept flexible requests and responses and make them |
| Collaborative | visible to appropriate supply-chain participants. |
| Optimization | Perform advanced multidimensional matching of flexible |
| | requests and responses, respecting constraints and |
| | optimizing overall utility. |
| Layer 4: | Provide a posting, matching and transaction arena for |
| Advanced | derivative offerings (transactions are actually |
| Financial | accomplished through Layer 2). |
| Mechanisms | |

### 1.4 Interface to Participant's Operating Systems

The entire collaborative exchange interfaces with participant's operating systems. For example, an hourly summary of consumer sales might cause a threshold to be crossed and trigger an ERP system to generate requests for raw-material replenishment to be sent to the exchange, and might also trigger a scheduling system to insert a production run in the current or next day's schedule.

Preferably, participants dealing with the exchange at the Collaborative Optimization layer have advanced scheduling and optimization systems. Later, if the decision is made to optimize at a transactional price level, participants may preferably have advanced pricing systems to allow them to evaluate the relative costs and benefits of different ways of fulfilling a need. Preferably, these systems are capable of automatic interactions with the Collaborative Exchange.

Preferably, communication protocols are XML based and, in the interests of interoperability and low cost-of-entry, conform to open standards such as those being developed by RosettaNet or UCCNet. Preferably, communication is conducted over 24/7 links in a zero-downtime network. Participants' systems should be similarly reliable.

### 2 Detailed Description of the Layers

### 2.1 Layer 2: Execution

The purpose of the Execution layer is to allow customers and suppliers to submit requests and responses (i.e., offers to buy or sell) and to execute transactions. Preferably, this layer does not do any automatic matching: one participant must recognize a potential match and submit it to the layer. If the corresponding response or request requires confirmation from the other participant, they are notified and can accept or decline the match. Both participants are notified electronically when a match is made and accepted, in a form that can initiate fulfillment and create appropriate records in an accounting system.

### 2.1.1 Simple Requests and Responses

The simple demand requests and fulfillment responses of the Execution layer contain lists of conditions, or specifications. There are many possible specifications and only a few may be included on any particular request or response. For example, a specification could be a time window for delivery, a quantity, a reliability, a set of acceptable suppliers, a price, a contract reference under which the request or response should fall, etc. Each of these specifications is a dimension of value of the potential transaction.

Price is merely one dimension of many, which may or may not be included. For example, if the transaction falls under a standing contract with pre-negotiated prices then price is not relevant.

Preferably, for a request and response to match, each item in their specification list must be satisfied: the delivery window in the response must fall within the requested delivery window, prices must match (if they are present), quality requirements must be met, limitations on who can supply be satisfied, etc.

Requests and responses may also specify who can view them. Each participant in the market receives information about requests and responses. In summary, a request or a response may have the following attributes:

Visibility: who can view the request or response

Owner: The party making the request or response

Validity: The duration for which the request or response is valid

Negotiation timeout: The time after which automatic matching should take the best available match and attempt execution. This allows for a period of negotiation in which participants can respond to a demand request with a fulfillment response (which may or may not exactly match the request), or counter-respond to a fulfillment response with a modified demand request (which again may or may not be an exact match for the fulfillment response.)

Confirmation: Whether or not confirmation is required to execute a transaction involving this request or response. A preconfirmed or firm request is an instruction to buy, whereas an request that does require confirmation is akin to an enquiry, and similarly with responses. The facility for confirmation is provided so that participants can explore multiple ways of accomplishing their needs, e.g., a logistics provider might enter requests or responses for many routes, but may only be able to actually service a few of them at one time because of a limited number of trucks.

Manual OK: Whether this request or response can match against one requiring confirmation (a participant might want to avoid requests and responses requiring confirmation because of the slower and less certain execution that confirmation entails)

Pre-execution explosion: Whether or not the demand or request can, before execution, be exploded into ingredients and propagated through Information Exchange layer to component suppliers

Execution explosion: Whether or not resulting transaction (if any) can be exploded into ingredients and propagated through Information Exchange layer to component suppliers

Specifications: List of specifications (conditions) on various dimensions of value. The specifications can be discrete (i.e., a single value that must be matched exactly) or interval (i.e., a range, e.g., a time window, or a list of discrete values, for which the response range must fall entirely within the request range for a match to occur. For example, conditions might include some of the following:

Item (e.g., SKU)

Quantity

Delivery time window

Quality guarantee/requirements

Fulfillment guarantee/penalty

Encompassing pre-negotiated contract

Price

Supplier restrictions

### 2.1.1.1 Scenario: Matching Simple Requests and Responses

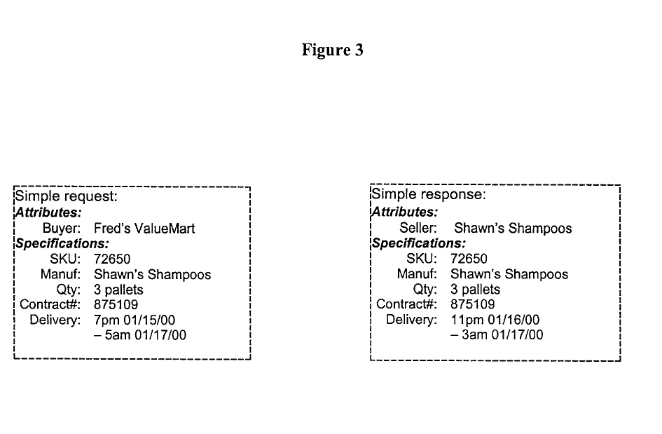

FIG. 3 shows a simple request and response. The request shown in FIG. 3 is an order from a particular manufacturer under a standing contract. It specifies the manufacturer and a contract identifier. This request and response match because all the discrete conditions match and for the one condition that is an interval (delivery), the interval in the response falls within the interval in the request.

### 2.1.2 Queries

A participant can query the exchange about what requests or responses match a particular request or response submitted by the participant. The exchange returns a list of matching requests or responses that the participant is permitted to view.

### 2.1.3 Matching and Execution

The owner of one of a pair of matching request and response can send a message to the system requesting execution. The system verifies that pair does indeed match (i.e., the response satisfied all the conditions of the request) and checks whether the other half of the matching pair has reached the end of its negotiation period, and whether it can be executed without confirmation. If either of these conditions is not met, the other party is contacted and allowed to accept or decline the transaction. If the transaction is accepted, the exchange executes the transaction and sends appropriate messages to the participant's accounting and operational systems.

### 2.1.4 Dissemination of Signals

Signals can result from each of requests, responses, and executed transactions. Whether or not information is conveyed, and the type of information (primarily temporal and regional aggregation) conveyed to other participants can be controlled by the originators of the response or request.

### 2.2 Layer 3: Collaborative Optimization

Various factors contribute to the need for the sophisticated multidimensional, combinatorial matching capability that the Collaborative Optimization layer provides:

1) Pressure to respond instantly to requests and responses.

2) Faster response times creates need for combinatorial (conditional) requests and responses—One can no longer sequentially explore alternatives, but must enter alternative requests and responses simultaneously, along with conditions specifying dependencies and alternatives.

3) Complexity finding a good match creates a need for automatic techniques for finding a good set of matches.

4) Need to maintain privacy—an automatic matching and optimization procedure can take confidential information such as costs or preferences into account without revealing it.

The Collaborative Optimization layer introduces many new features including: automatic matching and execution and flexible requests and responses. Automatic matching means that the exchange actively seeks matching requests and responses, and executes them as soon as their negotiation period has timed out, provided they are firm (no confirmation required).

In the Execution layer only simple requests and responses could be used; these simple requests and responses had only one set of specifications (conditions). Flexible requests and responses enhance simple requests and responses by expressing flexibility in how an request or response could be matched. The Collaborative Optimization layer also provides means for expressing preferences among the different ways of matching the demand or request, and for expressing dependencies among different requests and responses. Flexible requests and responses have the following attributes:

The same attributes concerning time and visibility as in simple requests and responses (although requests and responses requiring confirmation would probably be little used in layer 3, because of the greater importance of fast and automatic execution to participants using this layer)

Multiple sets of specifications. The request or response can be matched by satisfying just one of the sets of specifications.

Along with flexible requests and responses, participants can also specify utilities of different ways of matching a demand or request. In the simplest case, a utility could be specified for each set of specifications in a request or response. In more complex cases, utilities might be specified for combinations of possible matches. Participants also specify whether or not utilities are made visible when a transaction is executed. In one embodiment, utilities are visible and are restricted to reflecting only considerations related to level of service provided to the consumer, i.e., primarily avoiding out-of-stocks. This restriction, which could be specified in contracts or agreements, would prevent participants from using utilities as a surrogate for dynamic pricing.

### 2.2.1.1 Scenario: Matching a Flexible Request and Response

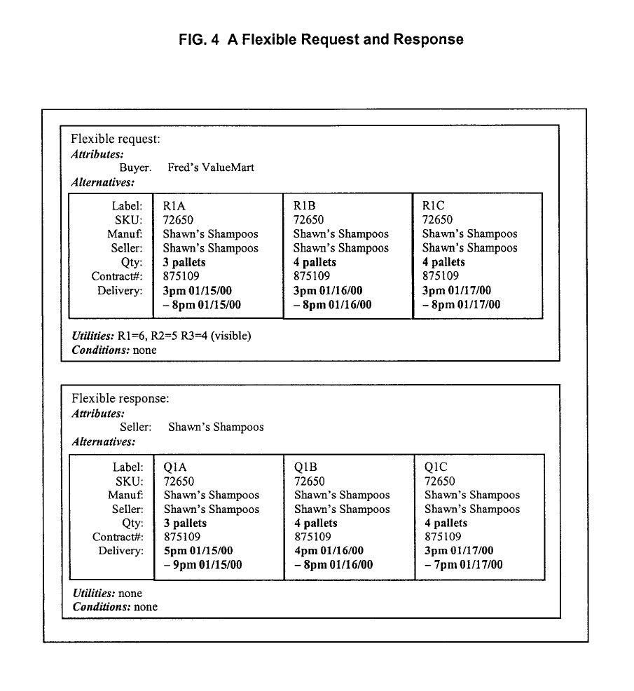

FIG. 4 shows a request and response having more flexibility than the simple request and response. In this request and response, the different conditions have different delivery dates and quantities in the specifications. The values in the conditions that differ between alternate Alternatives are shown in bold. Utilities are specified for each delivery date, as later delivery dates increase the potential for an out-of-stock situation.

In this scenario, Q1B matches R1B, and Q1C matches R1C. Note that Q1A does not match R1A because the delivery specification in the response does not satisfy the delivery response in the request.

The best way of satisfying the request is R1B/Q1B (utility 5, versus 4 for R1C/Q1C.)

### 2.2.2 Linked Requests and Responses—Multiway Matches

Participants can also specify conditions on combinations of matches. This supports automatic matching in situations where fulfillment of an request might involve multiple, coordinated transactions. For example, in response to a request for 6 pallets of Z with delivery by 6am Wednesday a manufacturer might submit a pair of mutually dependent requests and responses: a response to sell the 6 pallets of Z, and an request to deliver the 6 pallets of Z by 6am Wednesday.

### 2.2.2.1 Scenario: Matching Linked Flexible Requests and Responses

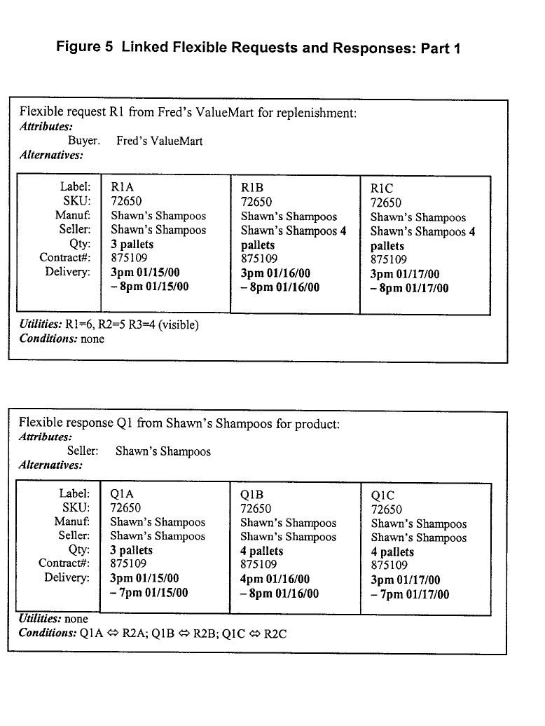

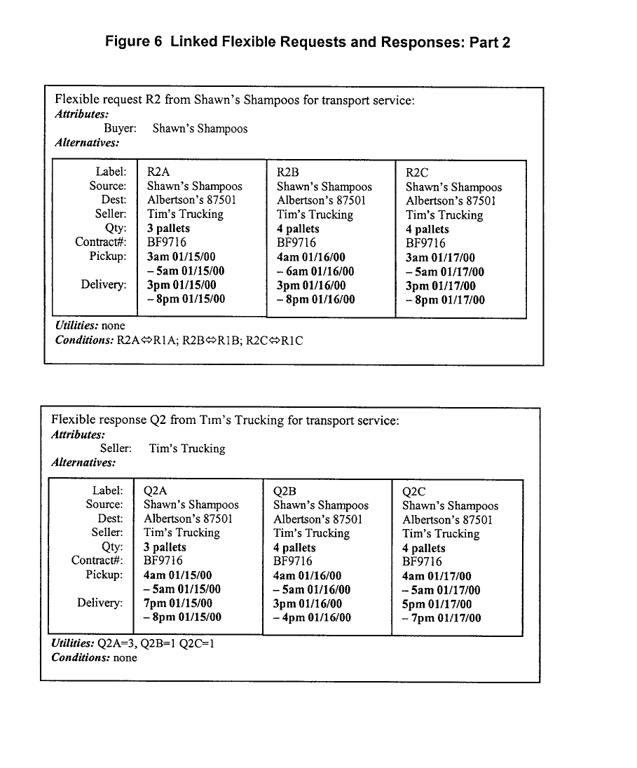

This scenario builds on the previous one by adding a corresponding flexible transport service requests for the flexible product response. The alternatives within the flexible service request are linked to the alternatives within the flexible product response. FIGS. 5 and 6 show four linked flexible requests and responses. The values of the specifications that differ between alternate specifications in one flexible request or response are shown in bold.

Now the possible matches, and corresponding total utilities are:

R1A/Q1A & R2A/Q2A 6

R1B/Q1B & R2B/Q2B 5

R1C/Q1C & R2C/Q2C 4

### 2.2.3 Weighted MAXSAT Problems and an Algorithm for Solving Instances

An instance of a weighted MAXSAT problem is a set of propositional clauses with a positive number (the weight) attached to each clause. The score of a truth assignment (an assignment of one of the values True or False to each of the variables that appear in the clauses) is the sum of the weights of the satisfied clauses (satisfied clauses are those that are true under the truth assignment). A solution is a truth assignment with a maximum score (i.e., a truth assignment that maximizes the sum of the weights of the satisfied clauses, or equivalently, that minimizes the sum of the weights of the unsatisfied clauses.)

A satisfiability problem with hard and weighted soft constraints (clauses) is one in which a solution to the problem MUST satisfy the hard constraints (clauses), and tries to maximize the sum of the weights of the satisfied soft constraints. Note that an instance of such a problem (in which the hard constraints initially have no weights) can be expressed as an instance of weighted MAXSAT as follows:

1. Let L be the sum of the weights of the soft constraints

2. Assign the weight L+1 to all the hard constraints with the additional restriction on solutions that the score of must be greater than or equal to N_{H}*(L+1), where N_{H} is the number of hard constraints.

A detailed description of the weighted MAX-SAT problem is provided in “Solving Problems with Hard and Soft Constraints Using a Stochastic Algorithm for MAX-SAT”, by Yuejun Jiang, Henry Kautz, and Bart Selman, 1^{st} International Joint Workshop on Artificial Intelligence and Operations Research, Timberline, Oreg., 1995, the contents of which are herein incorporated by reference.

### 2.2.4 Finding Optimal Matches

The collaborative optimization mechanism attempts to find a set of matches that maximizes overall utility. A customer whose need could be fulfilled in one of several ways can enter a flexible demand request, which specifies those different ways. A supplier responding to that request can enter a flexible response that specifies the different ways of fulfilling, which may or may not directly match the request. The collaborative optimization attempts to find the sweet spot of matching—the set of transactions where overall utility is maximized. The method by which this is done is as follows:

1. Convert the set of requests and responses into a weighted MAXSAT problem such that an optimal solution to the weighted MAXSAT problem corresponds to a consistent set of transactions that maximizes the overall utility.

2. Find an optimal, or at least a good, solution to the weighted MAXSAT problem using a weighted MAXSAT solver. As a non-limiting example, a published weighted MAXSAT algorithm may be used.

3. Communicate the resulting set of transactions to the relevant parties, and execute them. The information communicated to each participant in a particular transaction includes all the values of the attributes that were matched, but not the utility.

### 2.2.5 Translating Requests and Responses to a MAXSAT Problem

This section describes how a set of flexible requests and responses is translated into a set of weighted propositional clauses (i.e., a weighted MAXSAT problem).

First, some definitions:

1. Number the bids (i.e., requests or responses) from 1 to n, where n is the total number of bids. Let Bᵢ be the i^{th} bid.

2. There is a Boolean variable for each alternative in a flexible request or response. Let the Boolean variable Bᵢⱼ correspond to the jth alternative in bid i (a request or response). Let U(Bᵢⱼ) be the utility of the jth alternative in bid i (i.e., the utility of variable Bᵢⱼ), as specified by the submitter of the bid.

3. For each pair of alternatives from requests and responses that match, generate a Boolean variable D_{igjh} indicating a potential deal, i.e., a match between alternative g in request i and alternative h in request j. D_{igjh} is said to involve variables B_{ig} and Bⱼₕ. B_{ig} and Bⱼₕ are considered to match (and thus D_{igjh} exists) if the following two conditions are satisfied:

a) B_{ig} and Bⱼₕ have the same set of attribute ranges and the corresponding attribute ranges intersect.

b) The sum of the utilities of the alternatives B_{ig} and Bⱼₕ is greater than zero.

The translation proceeds by creating the weighted MAXSAT instance in the following manner:

1. Let C be the empty set. C will be the set of weighted clauses that forms that MAXSAT instance.

2. For each of the D_{igjh} add to C the clause consisting just of that variable, with a weight of B_{ig}+Bⱼₕ. Note that this weight is positive. Let L be the total weight of all these clauses. These clauses are the soft constraints. All remaining clauses to be added to C are hard constraints.

3. For a flexible request or response Bᵢ with k alternatives, Bᵢₗ . . . Bᵢₖ, add to C the following clause, consisting of a set of k(k−1)/2 disjunctive clauses: [symbol] { [symbol] B_{ig} [symbol] [symbol] Bᵢₕ, where g ε1 . . . k,h ε1 . . . k and g<h}. Let the weight of this clause be L+1. This clause ensures that a solution to C involves matches with at most one of the k alternatives of Bᵢ.

4. For each alternative B_{ig} from a request or response, collect the deal variables that involve it. If there are more than one, let them be denoted by D₁ through Dₖ. Add to C the following clause, consisting of the conjunction of k(k−1)/2 disjunctive clauses: [symbol] { [symbol] D_{g} [symbol] [symbol] Dₕ, where g ε1 . . . k,h ε1 . . . k and g<h}. Let the weight of this clause be L+1. This clause ensures that a solution to C involves at most one match with any alternative in any bid.

5. For each alternative B_{ig} from a request or response, collect the deal variables that involve it. Let them be denoted by Dₗ through Dₖ. Add to C the following clause: ( [symbol] B_{ig} [symbol] [symbol] D₁ [symbol] D₂ [symbol] . . . [symbol] Dₖ) . Let the weight of this clause be L+1. This clause ensures that if an alternative is selected in a solution to C, then some deal involving it is also selected.

6. For each of the D_{igjh} add to C the clause ( [symbol] D_{igih} [symbol] [symbol] (B_{ig} [symbol] Bᵢₕ)) with weight L+1. This clauses ensures that if a deal is made, then both alternatives it involves are selected.

7. Express each of the conditions attached to flexible requests or responses as prepositional formulas of the variables Bᵢⱼ and add them to C, with weights of L+1.

8. Let N_{H} be the total number of hard constraints (i.e., the total number of clauses added to C in steps 3 through 7).

Any feasible solution to the resulting weighted MAXSAT instance (i.e., an assignment of True or False to variables such that the total weight of unsatisfied clauses is L or less, but that does not necessarily maximize the total sum of satisfied clauses) specifies a set of accepted deals (the D_{igjh} that are assigned the value True) and selected alternatives (the B_{ig} that are assigned True) that satisfy the following conditions:

1. For each flexible request or response, at most one alternative is involved in an accepted deal.

2. If a deal is accepted, both alternatives it involves are selected (assigned true).

3. Each selected alternative is involved in exactly one accepted deal.

The utility of a feasible solution to the MAXSAT instance is the total weight of the satisfied clauses minus N_{H}*(L+1). An optimal solution to the MAXSAT instance is a feasible solution such that there is no other feasible solution with greater utility.

### 5 2.2.6 Solving the MAXSAT Problem

Ideally, the matching engine finds an optimal solution to the MAXSAT instance. However, it may also operate in a mode where due to the computational complexity of the instance, it does not always find the optimal solution, but merely a good one. This solution can still be used to specify a set of accepted deals. The participants must agree in advance to abide by the results of such a matching algorithm.

Potential algorithms for solving instances of weighted MAXSAT can be found in “Solving Problems with Hard and Soft Constraints Using a Stochastic Algorithm for MAX-SAT”, by Yuejun Jiang, Henry Kautz, and Bart Selman, 1^{st} International Joint Workshop on Artificial Intelligence and Operations Research, Timberline, Oreg., 1995, the contents of which are herein incorporated by references. Additional algorithms can be found in “A Multi-Attribute Utility Theoretic Negotiation Architecture for Electronic Commerce”, by Mihai Barbuceanu and Wai-Kau Lo, Proceedings of the 4^{th} International conference on Autonomous Agents, Barcelona, Spain 2000, pp 239-247, the contents of which are herein incorporated by reference. More algorithms can be found in B. Borchers and J. Furman. A two-phase exact algorithm for MAXSAT and weighted MAX-SAT problems. Journal of Combinatorial Optimization, 2(4):299-306, 1999, the contents of which are herein incorporated by reference.

### 2.2.7 Different uses of Utility

The utility optimization mechanism tries to find a set of transactions that maximizes the combined utility accruing from all accepted deals. What is done with those utilities after the deals are executed determines the type of interaction in the market, and also will affect how participants should design their bids in order to benefit maximally from interactions in the market.

After deals are executed, utilities accruing from executed deals can be allocated to participants in various ways, including, but not limited to, the following three and combinations thereof. Three utility allocation mechanisms can be summarized as collaborative, a utility sharing, or a price-competitive mode of operation, as follows:

1. In a collaborative mode of operation, utility values are guidelines that merely express preference. The participants must agree to cooperate in maintaining and monitoring reasonable utility ranges and fair utility gain. Periodic summaries of net utility accruing to different participants could be used to monitor agreements on utility setting, and, if necessary to maintain fairness, to adjust the relative weights of the utility of different participants. In this mode of operation, utility values will usually be positive, but may occasionally be negative.

The collaborative aspect to this mode of operation comes from the implicit agreement to be flexible and thus specify a variety of requests and responses, and from the implicit agreement to accept a potentially less attractive transaction on some occasions (without compensation), on the understanding that less attractive transactions will be rarer than more attractive transactions and that at the end of the day all parties will have received a net benefit. This mode of operation would be suitable for a market in which transactions occurred under prearranged contracts, with prices determined by the contract, or by prices specified in the attributes of requests or responses, i.e., a market in which utility was not identical to the currency in which goods or services were paid for.

2. In a utility sharing mode of operation, the utility accruing from a particular deal (which will be positive) is shared equally between the two participants in the deal. Participants in the market may wish to define a currency in which utility may be traded. As a non-limiting example, participants may agree in advance that at the end of the day, or some other prearranged period, they will conduct a pair-wise accounting, and for each pair of participants, the one having gained higher utility in transactions with the other will pay to the other half a unit of currency for every unit of utility in excess of the other.

Alternatively, participants may enter into other agreements on how utility results should affect their operations and contracts. The contracts could also specify constraints around how utility values were assigned by participants to requests and responses. This mode of operation would also be suitable for a market in which transactions occurred under prearranged contracts, with prices determined by the contract, or by prices specified in the attributes of requests or responses, i.e., a market in which utility was not identical to the currency in which goods or services were paid for.

3. In a price-competitive mode of operation, the utility accruing from a particular deal (which will be positive) is also shared equally between the two participants in the deal. However, this mode of operation differs from the utility sharing mode in that utility is directly identified with the currency in which goods and services are paid for, and participants are free to set the utilities of their bids and offers to any value they like. Immediately, or at some prearranged interval, participants pay for their excess utility accruing from a particular deal to the other participant in the deal, or are paid for their shortfall in utility by the other participant in the deal. This mode of operation would be suitable for a market in which utility is actually price: utility attached to requests to buy goods or services will be positive and is equivalent to the maximum price the buyer will pay, and utility attached to an offer to supply goods or services will be negative and is equivalent to the negative of the minimum price the seller is prepared to sell for. No other payments would be made for transactions.

### 2.2.8 Brokering Agents

In the utility sharing or price-competitive modes of operation it may also be useful to brokering agents. These agents inspect the entire set of potential deals and transfer utility among the alternatives of requests and responses in such a manner so as to make possible the achievement of sets of transactions with higher overall value. They do this by transferring some of the excess utility from potential deals that have a positive total utility to pairs of alternatives that would form a potential deal except that the sum of their utilities is less than zero. This converts such pairs of alternatives into potential deals and allows them to be considered as part of the match, thus potentially enabling a set of matches that has higher utility. Brokering agents are described in U.S. patent application Ser. No. 09/45,441, titled, “An Adaptive and Reliable System and Method for Operations Management”, filed Jul. 1, 1999, the contents of which are herein incorporated by reference.

### 2.2.9 Generation of Flexible Requests and Responses by Participants

Some sophistication is required to generate flexible requests and responses. The following levels of sophistication are some of those possible:

1. Manual generation of flexible requests and responses

2. Pre-defined sets of flexible requests and responses, possibly specific to a few broad situations (e.g., high demand in city X, high availability in city Y) Triggering of different sets could be manual or automatic.

3. Automatic creation of customized flexible requests and responses, rated based on detailed knowledge of the general costs and benefits of satisfying a particular request or response. The detailed knowledge could be similar to that involved in activity based costing. For example, the delivery of a half pallet of X could be rated based on the costs of the processes involved in fulfillment.

4. Automatic creation of customized flexible requests and responses, rated based on the combination of information about current operational conditions and detailed information of costs and benefits. E.g., if the manufacturer's system know that a batch of X was scheduled to come off the line in 7 hours, and that 7 pallets of the batch were not already assigned, this would make a offer of these 7 pallets more attractive to the manufacturer.

### 2.2.10 Queries

The automatic matching mechanism in layer 3 participants obviates, to a large extent, the need for simple queries as to what responses match a particular response, or vice versa. However, close-match queries are very useful—the results of such a query inform a participant of which requests or responses almost, but not completely, match one of their requests or responses. This assists the participant in refining their requests or responses so that a mutually advantageous match is possible. In effect, a close-match query is a mechanism for discovering the flexibility that another party is offering.

### 2.3 Layer 4: Advanced Market Features

If, eventually, the exchange acquires some of the characteristics of a mature financial market, it may become appropriate to add a layer supporting features such as the trading of futures and options. Futures could be used by participants wishing to avoid risk from possible fluctuations in availability or price, and options could be used for strategic purposes. E.g., a retailer considering a promotion in six months time could buy options on the product and service required for the promotion.

### 2.4 General Issues

There are a number of general issues concerning the operation of each layer or the entire exchange.

### 2.4.1 Data Mining

Data concerning consumer sales, demand requests and fulfillment responses from participants, and transactions may be mined to create various summaries and analyses. The resulting summaries and analyses may enable potential replacements for replenishment forecasting systems within the industry. Unless participants wished, these summaries would contain no information to identify participants, and would be aggregated over large numbers of individual events, somewhat like daily summaries of stock exchange activity that include total daily volume, and high, low and closing prices.

### 2.4.2 Information Security and Confidentiality

Information security is maintained through encrypting all transmissions and restricting network access to only authorized parties. Participants can specify what kind of information concerning consumer sales, requests, responses, and transactions is made available to other participants.

Although some supply chain members may be initially reluctant to share information with partners, the momentum of benefits accruing to those who do share information will encourage all to participate.

### 3 A Supply Chain Automated Matching Marketplace

The present invention further includes another embodiment of a supply chain automated matching marketplace. This embodiment includes a market between supply chain business partners that determines the best matching of flexibility between the partners. The cost of a service or product has two components: one is the acquisition cost of the product/service and the other is the operational cost. By describing needs and offers in multiple dimensions (as an example via the multi-dimensional automated market described in U.S. Patent Application titled, “A Method and System for Discovery of Trades Between Parties”, which was filed on Dec. 6, 2000 with attorney docket no. 9392-040-999, the contents of which are herein incorporated by reference) one can offer flexibility that can be used to reduce operational costs. This flexibility can be described in terms of pick-up time, delivery date, method of delivery, financing terms, quantity variations allowed, etc. Finding the optimal alternative may be found automatically using models of the buyer and seller (as described in U.S. patent application Ser. No. 09/345,441, titled “An Adaptive and Reliable System and Method for Operations Management”, filed on Jul. 1, 1999, the contents of which are herein incorporated by reference) or by rules or interaction as described in U.S. Patent Application titled, “A Method and System for Discovery of Trades Between Parties”, which was filed on Dec. 6, 2000 with attorney docket no. 9392-040-999.

The flexibility permitted in an offer requires a multi-dimension description of the product/service which makes it much more difficult to determine the best match between the buyer and seller. This suggest use of an automated market technique as provided by the above-referenced patent applications; but rather than having a bidding automated market among competitors, this embodiment of the present invention has an automated matching market among supply chain partners, or even among divisions within a company. The cost of the alternative solutions can be included as one of the dimensions, or can be pulled from an existing price schedule once the optimal choice of flexible alternatives has been selected.

This new type of market of the present invention has business advantages over the bidding types of markets, because it solves both of the problems described above for those markets. Any two partners can establish an effective market and others can be added as appropriated. In addition, this automated supply chain matching market rewards partners for working together and sharing the information necessary to better match preferences and reduce operational costs.

Whereas existing business-to-business markets have difficulty getting started due to liquidity problems, this business partner-to-business partner market can start with two partners, gradually add more partners and when desirable add bidding features gradually as appropriated and wanted.

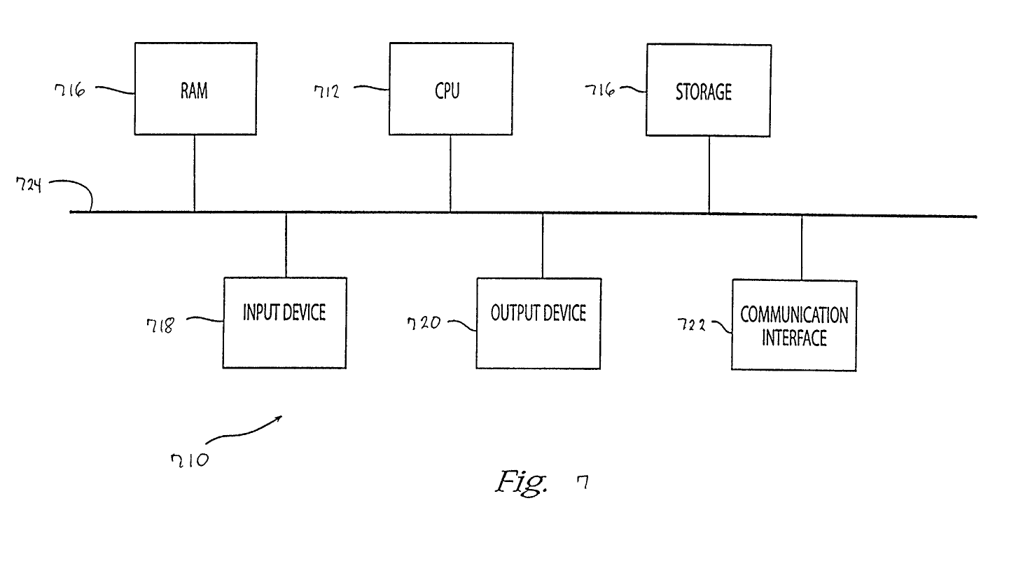

FIG. 7 discloses a representative computer system 710 in conjunction with which the embodiments of the present invention may be implemented. Computer system 710 may be a personal computer, workstation, or a larger system such as a minicomputer. However, one skilled in the art of computer systems will understand that the present invention is not limited to a particular class or model of computer.

As shown in FIG. 7, representative computer system 710 includes a central processing unit (CPU) 712, a memory unit 314, one or more storage devices 716, an input device 718, an output device 720, and communication interface 722. A system bus 724 is provided for communications between these elements. Computer system 710 may additionally function through use of an operating system such as Windows, DOS, or UNIX. However, one skilled in the art of computer systems will understand that the present invention is not limited to a particular configuration or operating system.

Storage devices 716 may illustratively include one or more floppy or hard disk drives, CD-ROMs, DVDs, or tapes. Input device 718 comprises a keyboard, mouse, microphone, or other similar device. Output device 710 is a computer monitor or any other known computer output device. Communication interface 722 may be a modem, a network interface, or other connection to external electronic devices, such as a serial or parallel port

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

1. A method for determining one or more matches among one or more bids submitted by one or more participants comprising the steps of:
defining one or more alternatives for at least one of the bids;
defining one or more conditions among said one or more alternatives; and
determining one or more combinations of said alternatives that satisfy said one or more conditions.

2. A method for determining one or more matches among one or more bids submitted by one or more participants as in claim 1 further comprising the step of:
defining at least one first utility for representing a vale of at least one of said combinations.

3. A method for determining one or more matches among one or more bids submitted by one or more participants as in claim 1 further comprising the step of:
defining one or more second utilities for representing a value of said one or more alternatives.

4. A method for determining one or more matches among one or more bids submitted by one or more participants as in claim 3 wherein said first utility of said at least one combination is defined as a sum of said one or more second utilities of those of said one or more alternatives that are in said at least one combination.

5. A method for determining one or more matches among one or more bids submitted by one or more participants as in claim 4 wherein said sum os said one or more second utilities is a weighed sum.

6. A method for determining one or more matches among one or more bids submitted by one or more participants as in claim 2 further comprising the step of:
determining at least one of said combinations that is optimal with respect to said at least one first utility.

7. A method for determining one or more matches among one or more bids submitted by one or more participants as in claim 1 wherein said determining one or more combinations of said alternatives that satisfy said one or more conditions step comprises the steps of:
representing said one or more alternatives and/or said one or more conditions with at least one satisfiability problem and
determining at least one solution to said at least one satisfiability problem.

8. A method for determining one or more matches among one or more bids submitted by one or more participants as in claim 7 wherein said representing said one or more alternatives and/or said one or more conditions step comprises the steps of:
defining at least one first variable Bᵢⱼ representing at least one of said one or more alternatives wherein said variable Bᵢⱼ corresponds to a jth one of said alternatives in an ith one o the bids.

9. A method for determining one or more matches among one or more bids submitted by one or more participants as in claim 8 wherein said representing said one or more alternatives and/or said one or more conditions step comprises the step of:
generating a first conjunction of one or more first disjunctive clauses of said at least one first variable Bᵢⱼ.

10. A method for determining one or more matches among one or more bids submitted by one or more participants as in claim 9 wherein said one or more first disjunctive clauses are defined as k(k−1)/2 disjunctive clauses: [symbol] { [symbol] B_{ig} [symbol] [symbol] Bᵢₕ, where g ε1 . . . k,h ε1 . . . k and g<h}.

11. A method for determining one or more matches among one or more bids submitted by one or more participants as in claim 9 wherein said representing said one or more alternatives and/or said one or more conditions step comprises the step of:
defining at least one second variable D_{igjh} representing at least one potential deal between two or more of the bids wherein said second variable D_{igjh} corresponds to said potential deal between a g th alternatives in an i th one of said bids and a h th one of said alternatives in a j th one of said bids.

12. A method for determining one or more matches among one or more bids submitted by one or more participants as in claim 11 wherein said representing said one or more alternatives and/or said one or more conditions step comprises the step of:
generating a second conjunction of one or more second disjunctive clauses of said at least one second variable.

13. A method for determining one or more matches among one or more bids submitted by one or more participants as in claim 12 wherein said one or more second disjunction clauses are defined as k(k−1)/2 disjunctive clauses: [symbol] { [symbol] D_{g} [symbol] [symbol] Dₕ, where g ε1 . . . k,h ε1 . . . k and g<h}.

14. A method for determining one or more matches among one or more bids submitted by one or more participants as in claim 12 wherein said representing said one or more alternatives and/or said one or more conditions step comprises the step of:
generating one or more third disjunctive clauses to represent said one or more conditions and generating a third conjunction of said one or more third disjunctive clauses.

15. A method for determining one or more matches among one or more bids submitted by one or more participants as in claim 14 wherein said representing said one or more alternatives and/or said one or more conditions step comprises the step of:
generating an overall conjunction of said first conjunction, said second conjunction and said third conjunction.

16. A method for determining one or more matches among one or more bids submitted by one or more participants as in claim 11 wherein said at least one satisfiability problem is a MAX-SAT problem.

17. A method for determining one or more matches among one or more bids submitted by one or more participants as in claim 6 further comprising the step of:
executing at least one of the matches for one or more of the bids that are identified by said at least one optimal combination.

18. A method for determining one or more matches among one or more bids submitted by one or more participants as in claim 17 further comprising the step of:
distributing said at least one first utility among at least one of the participants who submitted said one or more of the bids of said at least one optimal combination.

19. A method for determining one or more matches among one or more bids submitted by one or more participants as in claim 18 wherein said distributing said at least one first utility step comprises the step of:
allocating said at least one first utility evenly among the participants over time to achieve fairness.

20. A method for determining one or more matches among one or more bids submitted by one or more participants as in claim 18 wherein said distributing said at least one first utility step comprises the step of:
allocating said at least one first utility evenly among the participants for each of said executed matches.

21. A method for determining one or more matches among one or more bids submitted by one or more participants as in claim 1 wherein said bids comprise:
one or more requests from one or more products and/or services and
one or more responses identifying one or more capabilities of one or more products and/or services.

22. A method for determining one or more matches among one or more bids submitted by one or more participants as in claim 1 further comprising the step of:
defining one or more attributes for at least one of said bids.

23. A method for determining one or more matches among one or more bids submitted by one or more participants as in claim 22 wherein said determining one or more combinations of said alternatives step further comprises the step of:
identifying at least two of said alternative that have compatible ones of said attributes; and
assigning said identified alternatives to said one or more combinations.

24. A method for determining one or more matches among one or more bids submitted by one or more participants as in claim 22 wherein said attributes comprise one or more members of the set consisting of a visibility variable, an owner, a validity period, a negotiation timeout, a confirmation indicator, a manual indicator, a pre-execution explosion indicator, an execution explosion indicator.

25. A method for determining one or more matches among one or more bids submitted by one or more participants as in claim 22 wherein said attributes comprise one or more specifications.

26. A method for determining one or more matches among one or more bids submitted by one or more participants as in claim 22 wherein said one or more specifications comprise one or more members of the set consisting of stock keeping unit (SKU), a quantity, a delivery time window, a quality guarantee, a quality requirement, a fulfillment guarantee, a fulfillment penalty, a contract identifies, a price and a supplier restriction.

27. A method for determining one or more matches among one or more bids submitted by one or more participants as in claim 1 wherein said one or more conditions comprise one or more links between one or more groups of said alternative identifying relations between said alternatives within said group.

28. A method for determining one or more matches among one or more bids submitted by one or more participants as in claim 27 wherein said relations comprise at least one compatibility relation.

29. Computer executable software code stored on a computer readable medium, the code for determining one or more matches among one or more bids submitted by one or more participants, the code comprising:
code to receive one or more alternatives for at least one of the bids;
code to receive one or more conditions among said one or more alternatives; and
code to determine one or more combinations of said alternatives that satisfy said one or more conditions.

30. Computer executable software code stored on a computer readable medium, the code for determining one or more matches among one or more bids submitted by one or more participants as in claim 29, the code further comprising:
code to represent said one or more alternatives and/or said one or more conditions with at least one satisfiability problem and
code to determine at least one solution to said at least one satisfiability problem.

31. A programmed computer system for determining one or more matches among one or more bids submitted by one or more participants comprising at least one memory having at least one region storing computer executable program code and at least one processor for executing the program code stored in said memory, wherein the program code includes
code to receive one or more alternatives for at least one of the bids;
code to receive one or more conditions among said one or more alternatives; and
code to determine one or more combinations of said alternatives that satisfy said one or more conditions.

32. A programmed computer system for determining one or more matches among one or more bids submitted by one or more participants comprising at least one memory having at least one region storing computer executable program code and at least one processor for executing the program code stored in said memory as in claim 31, wherein the program code further includes:
code to represent said one or more alternatives and/or said one or more conditions with at least one satisfiability problem and
code to determine at least one solution to said at least one satisfiability problem.
